(19) United States
(12) Patent Application Publication
(10) Pub. No.: US 2026/0115773 A1
(43) Pub. Date: Apr. 30, 2026

(54) Waste Treatment Using a Molten Metal Reactor

(71) Applicant: Structured Nano Carbon LLC, Pensacola, FL (US)

(72) Inventors: Charles Danny Cross, Pensacola, FL (US); Gordon Gregory Pennington, Panama City, FL (US)

(73) Assignee: Structured Nano Carbon LLC, Pensacola, FL (US)

(21) Appl. No.: 18/957,186

(22) Filed: Nov. 22, 2024

Related U.S. Application Data
(60) Provisional application No. 63/603,752, filed on Nov. 29, 2023.

(51) Int. Cl. B09B 3/70; B09B 3/40; B09B 101/65

(52) U.S. Cl. CPC B09B 3/70; B09B 3/40; B09B 2101/65

(57) ABSTRACT

A molten metal reactor comprising at least the following components a) through c): a) a reactor vessel comprising a molten metal bath, b) a waste input assembly, and c) a product removal assembly. A process to treat a waste material, the process comprising adding the waste material to a molten metal reactor as described herein.

### REFERENCE TO RELATED APPLICATIONS

This application claims the benefits of U.S. Provisional Application 63/603,752, filed on Nov. 29, 2023.

### BACKGROUND

There is a critical need for good, efficient, and cost-effective alternatives for the disposal of industrial, medical, and household waste. There is currently no viable alternative for the disposal of many of these substances. Many industrial entities retain hazardous wastes, created as byproducts of their manufacturing processes, in large storage structures on the premises of their industrial plants, due to the lack of any practical alternative. Shipping hazardous waste to landfills for storage of indefinite duration poses unacceptable risks to the public, environment, and also incurs potential liability issues. Many wastes that could otherwise be disposed of by landfilling, or even by recycling, are now incinerated because of the metals in the materials.

Such incineration leads to an increase in air pollution.

The disposal of medical waste is an environmental concern, as many medical wastes are classified as infectious or biohazardous, and could potentially lead to the spread of infectious disease. Improper segregation and disposal of medical waste has the potential to contaminate groundwater sources, produce air pollutants, and move into the ecosystems of wildlife, which in turn, may affect animals and humans alike.

Much household waste is disposed of in landfills. Landfill sites are often responsible for the contamination of soil and groundwater, as the contaminating materials (such as heavy materials like lead and mercury) spread to the soil and water sources. Along with methane, landfills also produce carbon dioxide, water vapor, and trace amounts of oxygen, nitrogen, hydrogen, and non-methane organic compounds. These gases can also contribute to climate change and increase smog formation. Daily exposure to waste sites (for example, landfills) leads to an accumulation of harmful substances and/or microbes in a person's body. There is a need for new efficient waste treatment processes that renders most waste streams harmless. U.S. Pat. No. 6,227,126 discloses a waste treatment apparatus comprising the following: (a) an elongated reaction chamber; the elongated reaction chamber having an inlet end and an outlet end, and also including a gas containment boundary extending along its length; (b) a supply chamber containing a supply of reactant metal; (c) a heater for maintaining at least a portion of the reactant metal in the supply chamber in a molten state; (d) a circulating arrangement for circulating molten reactant metal in a circuit from the supply chamber through the reaction chamber in the direction from the inlet end to the outlet end; (e) a mixing arrangement for mixing molten reactant metal within the reaction chamber and for mixing gases contained within the reaction chamber; (f) a waste input arrangement for admitting waste material into the reaction chamber, and (g) a reaction product removal arrangement for receiving reaction products from the reaction chamber. See claim 1. Solids and liquid reaction products, along with slag, all collect, such that the surface of molten reactant metal 15 in an outlet chamber 57 is skimmed or scraped by skimming member 63, off into an outlet chute 66 (see column 10, lines 10-13). See also, column 8, lines 20-27.

U.S. Pat. No. 6,929,676 discloses a treatment apparatus (10) that includes a liquid reactant metal containment vessel (11) for containing a first liquid reactant metal, a release chamber (14) adapted to receive the first liquid reactant metal from the containment vessel (11), and a submerging arrangement (21) adapted to dunk or submerge a container (46) of feed material into the liquid reactant metal, and move the container to a release location within the release chamber (14). Relatively light materials rising from the submerged container (46), including unreacted feed material, intermediate reaction products, and perhaps final reaction products, collect in a collection area (60) having an upper surface defined by an upper surface of the release chamber (14). A treatment arrangement, included in the apparatus, places fluids, collected in the collection area (60), in contact with the first liquid reactant metal or a second liquid reactant metal, for a sufficient period of time, to effect the desired reduction reactions. See Abstract. Solids comprising slag collecting at the surface of the liquid reactant metal in the output chamber, and some liquids, are preferably removed by a suitable skimming system (column 3, line 66 to column 4, line 2). See also, column 10, line 59, to column 11, line 1. See also U.S. U.S. Pat. No. 6,669,755.

Other reactors and/or processes are disclosed in the following references: U.S. Pat. Nos. 5,000,101; 5,167,919; 5,273,341; 5,359,947; 5,452,671; 5,461,991; 6,037,5176,069,290; 6,195,382; 6,346,221; 6,355,857; 6,717,026; 7,034,197; 7,365,237; 7,449,156; 8,299,014; U.S. Publication 2002/0072644 and U.S. Publication 2005/0254988.

However, the molten metal reactors of the art suffer from one or more of the following issues: a) build-up of coke within the injection nozzle(s), b) build-up of slag within the reactor, typically due to the leakage of oxygen into the reactor, c) insufficient flow of an injected feed source within the reactor, d) energy dissipation away from the reactor, e) inefficiencies associated with conventional reactors, f) the lack of control over the reaction process and g) the inefficient flow of injected material leading to undesired decomposition reactions. As discussed, there remains a need for efficient and cost-effective waste removal systems for a wide range of materials, and which render most waste materials harmless. This need has been met as discussed below.

### SUMMARY OF INVENTION

A molten metal reactor comprising at least the following components a) through c):
a) a reactor vessel comprising a molten metal bath;
b) a waste input assembly; and
c) a product removal assembly.

### BRIEF DESCRIPTION OF THE DRAWINGS

FIG. 1 depicts a molten metal reactor.

FIG. 2 depicts a removable plug unit showing an injection port mounted on the underside of the plug unit.

FIG. 3 depicts a removable plug unit, supporting a vertical screw auger on its upper surface, and an injection port attached to its lower surface.

FIG. 4 depicts the configuration of an injection port.

FIG. 5 depicts a molten metal reactor containing a product removal assembly of the shown configuration.

FIG. 6 depicts a collection chamber.

FIG. 7 depicts a molten metal reactor containing a slag rake assembly.

FIG. 8 depicts a slag paddle device.

FIG. 9 depicts a cross-sectional view of a slag paddle device, along the vertical length of the movable slag paddle.

FIG. 10 depicts an upper elevation view of a slag rake assembly.

FIG. 11 depicts a side view of a slag rake assembly, showing the transition of a slag paddle, from insertion into a molten bath, to the movement along an insert, to an outlet chamber. The slag carried along with the slag paddle, enters the outlet chamber, falls onto an outlet door below, which then opens to release the slag into a collection container.

FIG. 12 depicts a portable plug unit.

FIG. 13 depicts some plug units covering portions of a reactor vessel.

FIG. 14 depicts a molten metal circulating pump installed into a removeable plug assembly.

FIG. 15 depicts a cross-sectional view of a portion of a molten metal reactor.

FIG. 16 depicts a launder makeup vessel containing a transfer pump, and used to provide makeup molten metal to offset metal lost primarily due to the formation of slag.

### DETAILED DESCRIPTION

As discussed above, a molten metal reactor is provided, which comprises at least the following components a) through c): a) a reactor vessel comprising a molten metal bath, b) a waste input assembly, and c) a product removal assembly.

This reactor can be used to treat waste material and can be used to reduce hazardous wastes to elemental carbons and simple salts. Typically, a small number of base metal oxides, minerals, and silicates, along with any non-sublimable materials, are synthesized and form a slag. The metal oxides float to the surface of the molten metal bath. These low-energy, nontoxic, reaction residuals are removed from the surface of the bath and collected for disposal or recovery. Most of these residues can be separated for further reclamation or recycling, while the remainder can be deposited directly into a landfill. Thus, the slag typically does not contain any toxic or classified products, and can be landfilled or recycled as desired.

The primary volatile (or off-gas) components are gases (for example hydrogen) and elemental forms of carbon. Carbon can be removed, as a solid, from the off-gas stream with filters or cyclones, and may be recycled or landfilled. Solid waste by-products are typically innocuous, and can either be recycled or landfilled. Aluminum chloride or other base metal salts can be formed when halogenated compounds are processed. These can be removed by water scrubbing and separated for recycling.

Gas waste can either be safely released, or scrubbed and treated, with conventional technology (depending on feedstock), and the final end-products can be recycled or landfilled. This waste treatment process may reduce the overall volume of the material being treated by as much as 90%.

The molten metal bath can be used to chemically decompose complex organic waste, dissolve metals, and destroy certain pathogenic organisms found in any biomedical waste. A controlled reaction chamber atmosphere that excludes oxygen can be formed by using a positive pressure purging system. Very low gas flow volumes, along with a very short ducting chamber, may virtually eliminate the problems found in incinerator facilities, such as incomplete combustion and failure to capture particulates emerging from the incineration process.

End products from the destruction of biomedical waste are primarily gaseous carbon and water vapor. Any glass present will form a slag on the surface of the molten metal alloy. The glass can be sterilized, but not molecularly decomposed. Volume reduction for biomedical waste may be in the range from 80 to 99%. Any glass slag can be separated from the molten metal bath by skimming. It can then be taken to a recycling center or a landfill.

This waste treatment process, as described herein, provides significant cost reductions. The process can also removes metals, while treating or decomposing other mixed hazardous wastes and/or waste chemicals in materials being treated and/or halogenated organics. All of these contaminants can be removed in a single treatment cycle. The process has applications in removing metals, especially precious metals from spent catalysts. It does not make any difference whether or not any organics are present. This process can be used to remove lead from soils around battery manufacturing facilities, or older gasoline terminals.

A molten metal reactor may comprise a combination of two or more embodiments as described herein. A related waste treatment process may comprise a combination of two or more embodiments as described herein.

The claims at the end of this application set out features of the reactor and processes described herein. The various advantages and features of such will be better understood by reference to the following description of illustrative embodiments, read in conjunction with the figures introduced above. The following embodiments apply to the reactor and to processes using the same, unless otherwise noted.

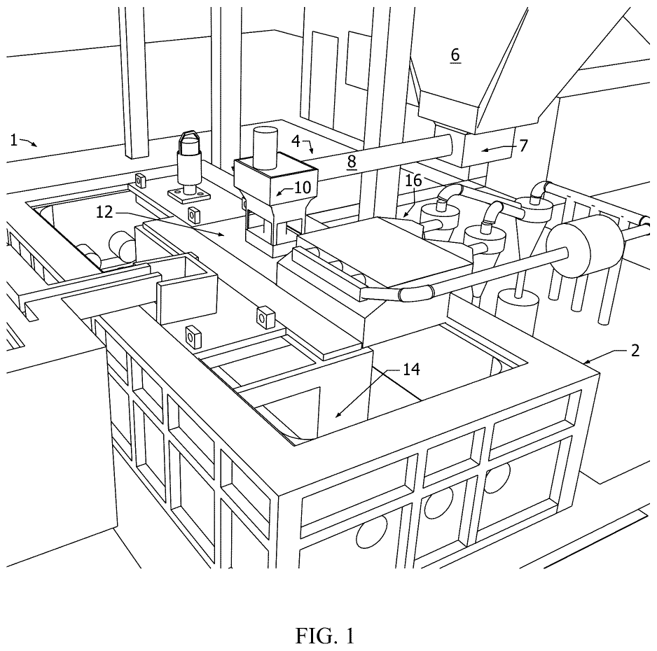

In one embodiment, or a combination of two or more embodiments, each described herein, referring to FIG. 1, the molten metal reactor 1 contains a reactor vessel 2 comprising a molten metal bath (not shown), and a waste input assembly 4, which contains an input hopper 6, a shredder 7, an auger conveyor 8, a vertical screw auger 10, and a plug unit 12, onto which the vertical screw auger 10 is mounted on its top surface and an injection port (not shown) is mounted onto its bottom surface. The input hopper 6 receives waste material, and the shredder 7 at the bottom of the hopper reduces the size of the material. An inclined conveyor (not shown) can be used to feed the waste material into the input hopper. The auger conveyor 8 routes the waste material to the vertical screw auger 10, which routes the waste to the injection port (not shown) connected to the plug unit 12. The reactor also comprises a partition 14 within the bath, which helps to create a circular or semi-circular flow of the molten metal in the bath. A product removal assembly 16 is also shown in FIG. 1. Here, the process is conducted in a closed-circuit recirculating system, where an anaerobic environment is maintained throughout the inside of the reactor, including processing apparatuses and chambers and gas lines. A system pressure control and monometer can be used to monitor the sealed reactor for leaks, and as needed, a small positive back pressure (for example, 0.020 psi to 0.035 psi) of an inert gas, such as argon, can be applied to the reactor to prevent air from seeping into the recirculation line, and other lines. Note, the inert gas may also be fed to the reactor (for example, to the waste input assembly), using an on-line feed system (for example, piping components and gauges), from a chemical plant that manufactures the inert gas.

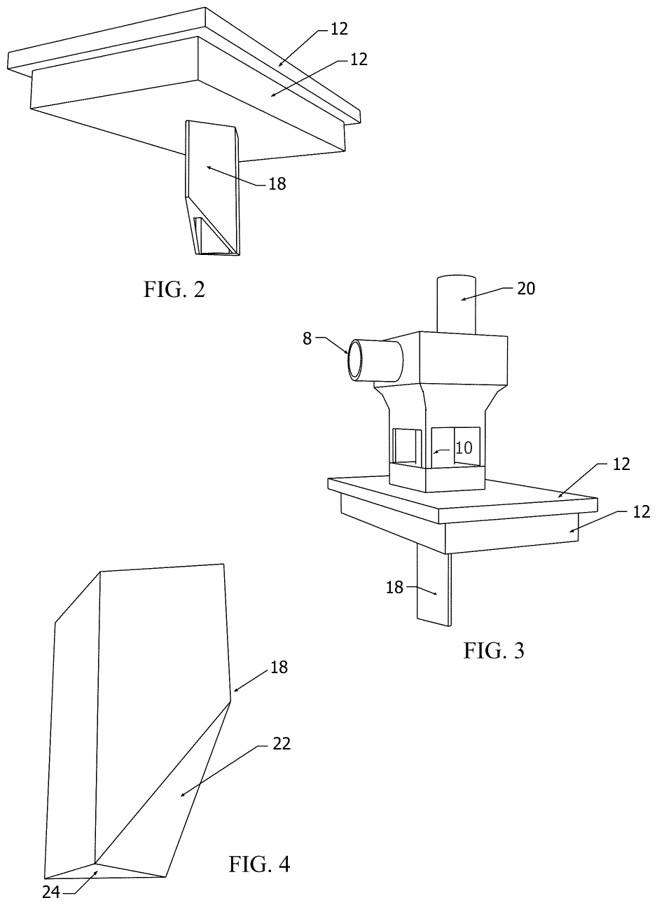

In one embodiment, or a combination of two or more embodiments, each described herein, the plug unit 12 is a removable block, as shown in FIG. 2, for the facilitation of equipment repair and the minimization of the repair time. As shown in FIG. 2, an injection port 18 is attached to the bottom surface of the plug unit 12. The removable plug unit allows for a rapid equipment replacement as needed and seals the surface of the molten metal from atmospheric oxygen. FIG. 3 shows the removable plug unit 12, with the vertical screw auger 10 attached to the top surface of the plug unit 12, and the injection port 18 attached to the bottom surface of the plug unit 12. In this embodiment, the vertical screw auger is driven by a motor 20. If the screw in the auger breaks or becomes jammed, this plug unit 12 and its supported components can be removed and replaced with a spare during the necessary repair of the auger. If the injection port becomes plugged, this unit can also be removed for repair of the injection port. The inlet of the auger conveyer 8 is also shown in FIG. 3.

In one embodiment, or a combination of two or more embodiments, each described herein, the injection port 18, as shown in FIG. 4, has a tapered surface 22 extending down to the exit of the injection port 24. The injection port 18 is the final device just prior to the injection of the waste material into the molten metal bath. A large surface area of the port is submerged under the surface of the molten metal bath. The port is configured to create a dual venturi annulus around the exit of the injection point. The vertical insertion of the injection port into the molten metal bath helps to provide a narrow flow path displacement of the metal bath around the injection port, thereby increasing the velocity of the molten metal around the injection port, which helps to entrain the waste material rapidly into the reactive molten metal. This action will create enhanced mixing and accelerate the reactive destruction of the injected material.

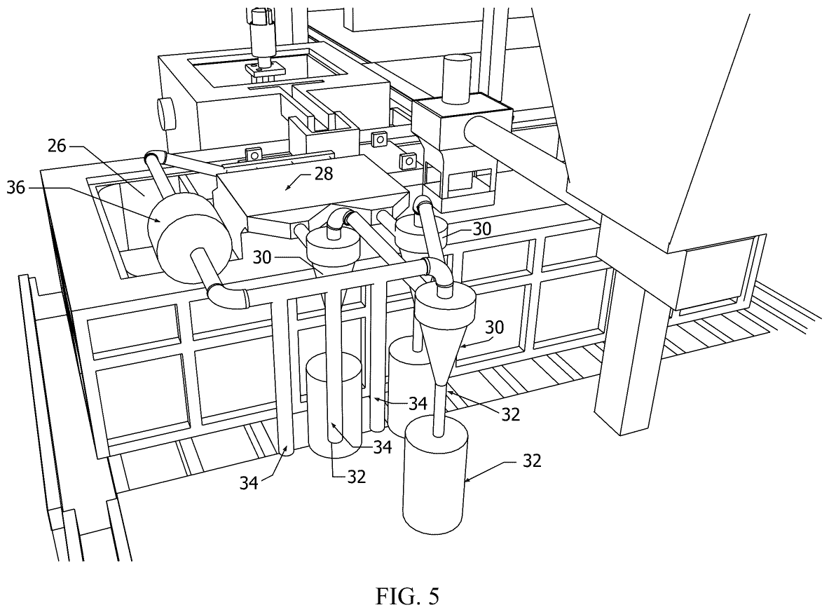

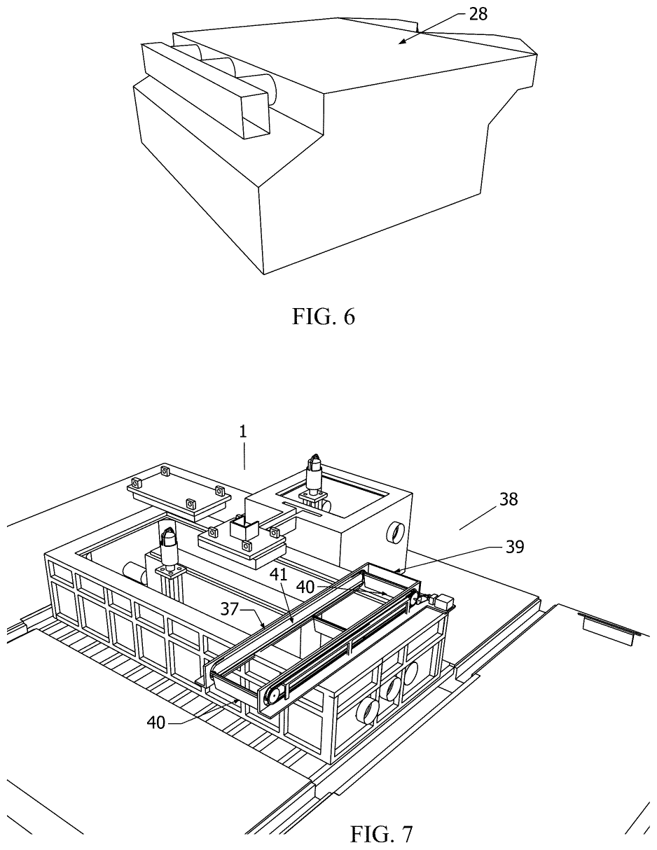

In one embodiment, or a combination of two or more embodiments, each described herein, a product removal assemble configuration 26 is shown in FIG. 5. The product removal assembly 26 contains a collection chamber 28, three cyclone separators 30, and three collection barrels 32. Here, the product removal system is a closed-circuit recirculating system. The collection chamber 28 is downstream from the injection port (not shown in this figure). The reaction of waste material with the molten metal bath typically produces numerous small particles and one or more gases, which can arise from the molten bath. The particles may easily become airborne and spread across the facility equipment and floors. To maintain full control of the waste process, these particles are contained and packaged. The collection chamber 28 is a large metal box that has cross-flow ventilation that sweeps the airborne particles toward the cyclone separators 30, which use a vortex separation and/or a centripetal force to transport the particles to the respective collection barrels 32. As shown in FIG. 5, two cyclone separators 30, arranged in a parallel configuration, discharge into a third cyclone separator 30 to assure a maximum collection of the airborne particles. In addition, downstream are three drop tubes 34 that assist in scavenging the remainder of the fugitive particles, prior to recirculation of an inert purge gas to an axial circulating fan 36 and then to the inlet of the collection chamber 28. Gases other than the inert gas (for example, hydrogen), may be separated via a vent in the collection chamber 28, and may be collected using one or more other devices. In one embodiment, the collection chamber extends over a large portion of the molten metal bath to fully cover the material reaction area downstream of the injection point, and thereby limit possible excess slag buildup. See also FIG. 6, which shows a side angle view of a collection chamber 28.

In one embodiment, or a combination of two or more embodiments, each described herein, referring to FIG. 7, the molten metal reactor I contains a slag rake assembly 38, which comprises a slag rake 39 and at least two slag paddles 40. In one embodiment, only two paddles 40 are used, such that at the completion of a slag removal cycle, the two slag paddles are stored at each respective end of the slag rake 39, so they are clearly removed from the molten metal bath. Constant contact with the molten metal will quickly erode the paddles 40. In one embodiment, the slag rake assembly 38 is positioned across the reactor and within several feet (for example, 8-10 feet) of the waste input assemble (not shown in this figure). Slag rises to the surface, as a result of the movement of the bath's circulation in its circular or semi-circular path. Slag is collected from the surface of the bath by at least one slag paddle 40, positioned in the return path of the bath, and submerged, for example, several inches (for example, 1 ½-2 inches) below the bath's surface. The slag paddle 40 blocks and collects the slag, and the rate of accumulation of the slag can be controlled by an automatic time cycle of the slag rake assembly 38. The slag paddle 40 also limits the carryover of slag particles that would possibly contaminate the molten bath. Each slag paddle 40 moves along a track 37 that surrounds a central surface area 41 of the slag rake 39. This slag rake assembly 38 can provide automatic slag removal, without the exposure of the molten metal to personnel and without exposure of the reactor to the atmosphere. In one embodiment, the reactor has an automatic slag removal cycle based on a programmed time interval, which can be manually actuated at any time, as required.

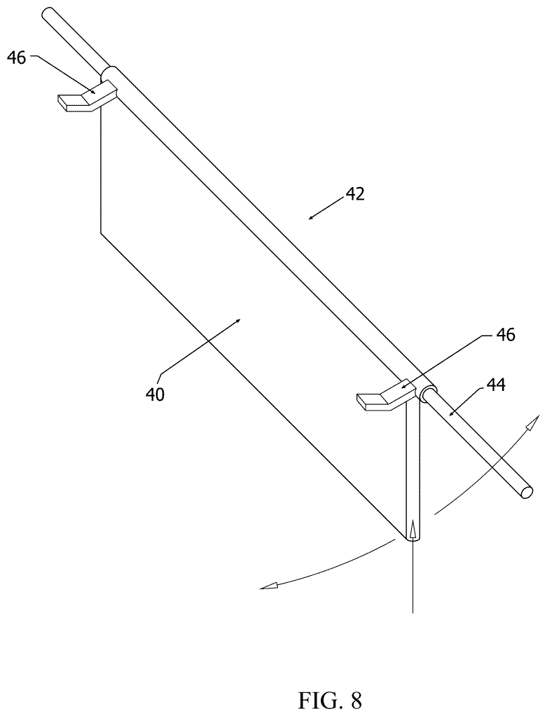

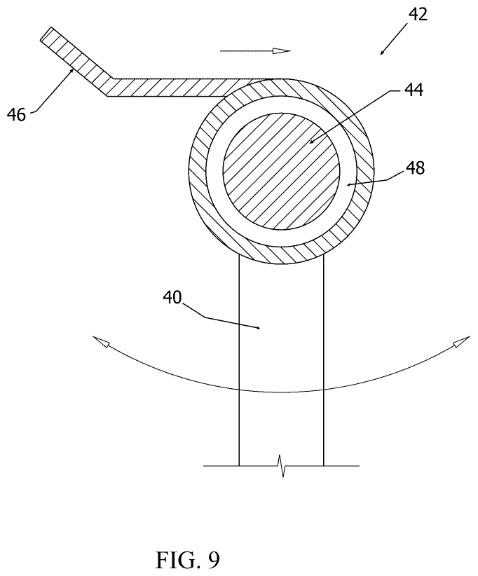

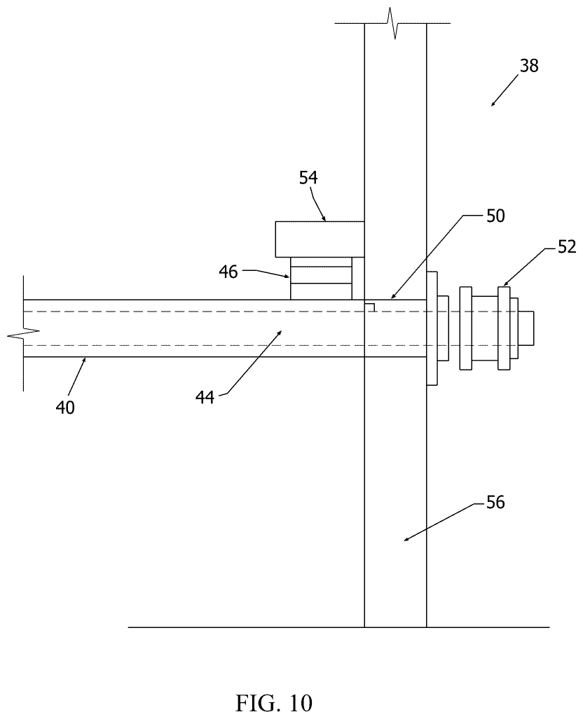

In one embodiment, or a combination of two or more embodiments, each described herein, as shown in FIG. 8, each slag paddle 40 of a slag paddle device 42 is assembled, such that a solid rod 44 is inserted through the upper circular surface of the slag paddle 40. The slag paddle 40 is free to rotate around the axis of the solid rod 44 to accommodate the inclined sections of the travel of the paddle and to allow each paddle to be stored in an elevated position while awaiting the next cycle. This configuration also contains two wiper arms 46, used to limit the rotation of the slag paddle 40 during the slag removal cycle (paddle held vertical), but to allow a free swinging motion at each end to accommodate the inclined planes. An end view of the slag paddle device 42, along the vertical axis of a slag paddle 40, is shown in FIG. 9. Here, it is noted that the upper circular surface of the slag paddle 40 forms a hollow tube 48, through which the solid rod 44 is passed through. A wiper arm 46 is also shown in FIG. 9. An elevation view of the slag rake assembly 38, including a track 56, is shown in FIG. 10. Here the solid rod 44 passed through a travel slot 50 in the slag rake support structure. The rod 44 is attached to a linked chain 52. The wiper rail 54 serves to assure that the slag paddle is held in a full vertical position while gathering and sweeping the slag to a discharge point. The linked chain 52 can be moved using, for example, a chain and sprocket mechanism (not shown) or a pully mechanism (not shown). The elevation surface of a slag paddle 40 and the elevation surface of a wiper arm 46 are also shown in FIG. 10.

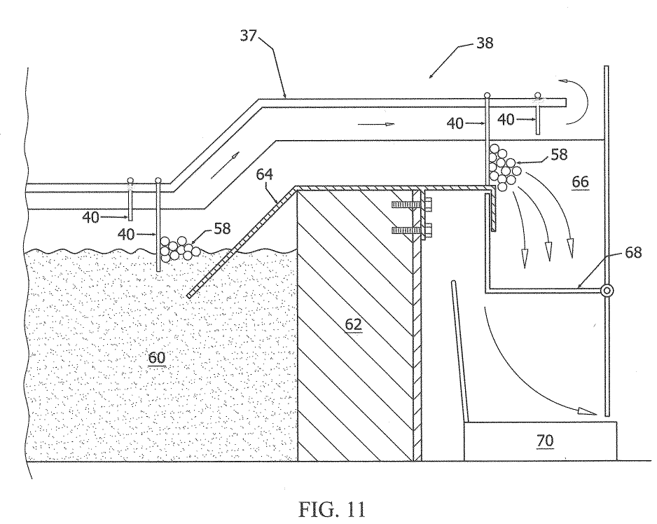

In one embodiment, or a combination of two or more embodiments, each described herein, a cross-sectional view of the operation of the slag rake assembly 38 during a reaction is shown in FIG. 11. Here, the two slag paddles 40 on the slag rake assembly 38 move in a counter-clockwise direction, along a track 37, as shown. Each slag paddle 40 collects slag 58 on the surface of the molten metal bath 60 contained within a refractory wall 62 surroundings. Next, the slag paddle 40 transports the slag 58 along an insert 64, to an outlet chamber 66. There, the slag 58 drops onto an outlet door 68, which then opens to release the slag 58 into a collection container 70. The outlet door 68 may be spring-loaded and/or solenoid operated by a limit switch. The outlet door 68 remains in the “closed position,” and only opens to dump slag 58 into the collection container 70. The insert 64 may be removable for a ready replacement. The slag rake assembly 38 may be driven by a chain and sprocket mechanism (not shown) or a pully mechanism (not shown). Here, the two slag paddles 40 are positioned at opposite ends of the slag rake track 37. Note, other types of equipment for the removal of slag are available from DY-KAST Supply and Equipment Company, STC and TIMESAVERS.

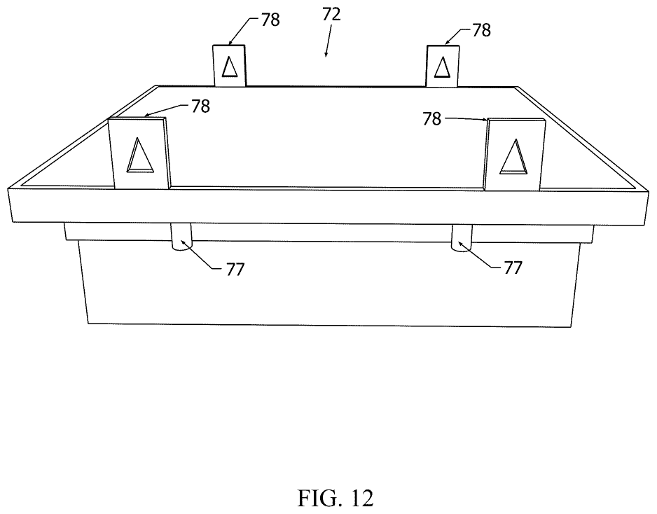

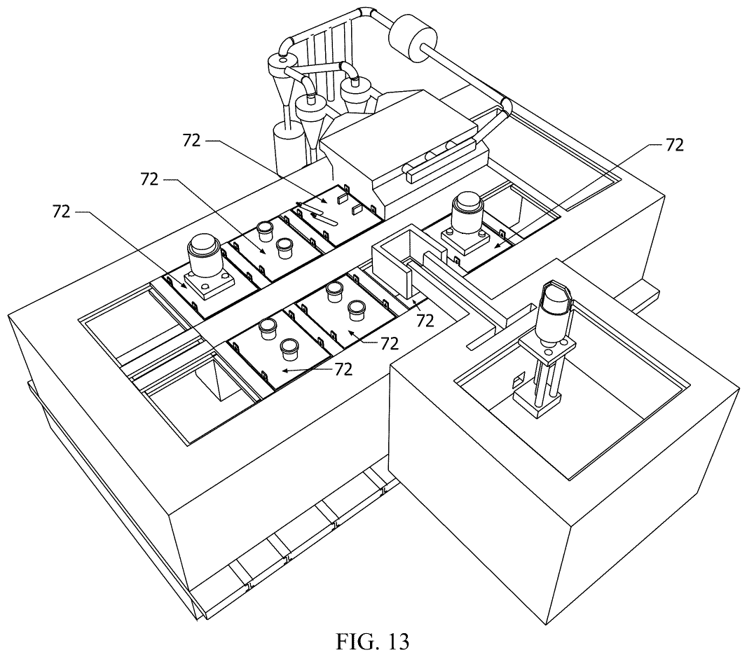

With any molten metal bath, the exposure of the bath surface to the atmosphere results in continuous absorption of oxygen and the formation of slag. This reduces the efficiency of the molten bath and results in the depletion of the bath, due to the formation of the slag. In one embodiment, or a combination of two or more embodiments, each described herein, the amount of exposure to oxygen is reduced by using a series of plug units, for example refractory plug units. See FIG. 12 for an example of a plug unit 72. The plug unit 72 is typically made from a molded refractory block. The plug unit 72 has several purposes. Mainly to provide a sealing surface over the molten bath to limit the exposure to oxygen, and to provide a structural surface to support, as needed, the installation of various reactor items. Lifting pad eyes 78 are positioned to allow an overhead crane to fully lift each plug and position that plug into a storage stand. Spare parts, (such as a plug), can be pre-staged in a storage location, and if a plug failure should occur during processing operations, the failed plug can be quickly removed and replaced with the ready spare to maintain operational needs. Alignment pins 77, to help align the pins onto the reactor surface, to assure the correct alignment of each plug unit in the reactor base, are also shown in FIG. 12. These pins also allow for the rapid removal and/or replacement of a plug unit during operational changes. When the reactor is in an operating configuration, all of the open surfaces over the reactor vessel will be covered with one or more plug units. FIG. 13 shows plug units 72 covering portions of the reactor vessel. In one embodiment, or a combination of two or more embodiments, each described herein, an electric resistance heater is embedded into a plug unit, and further the heater can be readily removed from the plug unit without the need to remove the plug unit.

It is noted, that to initially form the molten metal bath, metal ingots (for example, aluminum ingots) are added to the reactor vessel. The ingots are melted using one or more gas burners installed on one or more removable plug units. Examples of gas burners include natural gas forced air burners. Once the temperature of the bath is established at a temperature of about 80 degrees Fahrenheit (27° C.) higher than the operational bath temperature (ingots are in liquid form), as noted by several thermocouples placed inside the bath, the heating system for the reactor is carefully and controllably transferred from a “phase 1—gas burner” system, to an intermediate “phase 2—gas burner/electric resistance heater” system, and then carefully and controllably transferred from this “phase 2” system, to a “phase 3—electric resistance heater” system. Each gas burner is removed and replaced with an electric resistance heater. This process is continued until all the gas burners are replaced with electric resistance heaters. An electric resistance heater may be mounted on a removable plug unit, so that the heating element of the heater is inserted into the molten metal bath.

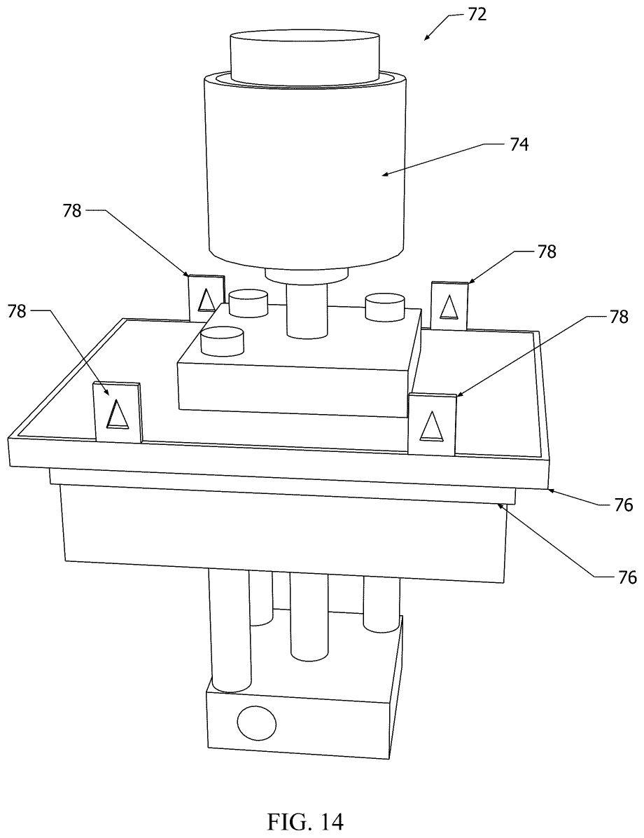

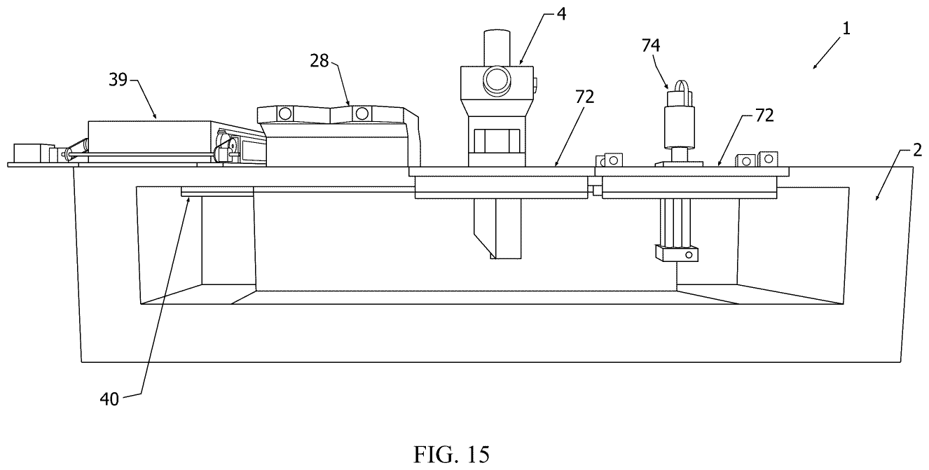

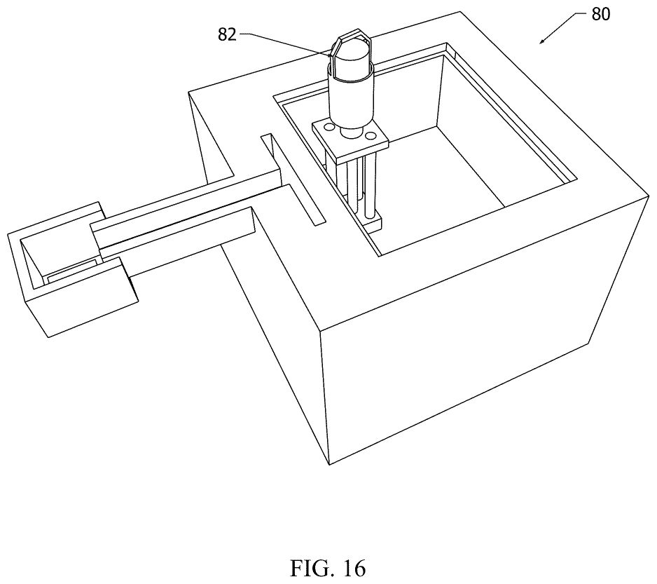

A removable plug unit 72, on which a circulation pump 74 is mounted, is shown in FIG. 14. Lifting pad eyes 78 are also shown in this figure. An edge and a portion of the lower surface area of the plug 76 are also shown. Circulation pumps are available, for example, from Molten Metal Equipment Innovations. FIG. 15 is a cross-sectional view of a portion of a molten metal reactor 1, showing a reactor vessel 2, a circulation pump 74 mounted on a plug unit 72, a waste input assemble 4 mounted on a plug unit 72, a collection chamber 28, and a slag rake 39. The lower bottom surface of each plug unit is inserted into the molten metal bath. The lower end of each slag paddle 40 is also inserted into the molten metal bath. In one embodiment, the side walls of the reactor vessel 2 have a thickness from 20 inches to 30 inches, and the base of the reactor vessel 2 has a thickness from 20 inches to 35 inches.

In one embodiment, or a combination of two or more embodiments, each described herein, a launder makeup vessel 80, as shown in FIG. 16, is positioned alongside a reactor (not shown) to transfer molten metal to the main operating bath (not shown) in a reactor vessel. In one embodiment, a transfer pump 82, installed in the launder makeup vessel 80, uses a discharge head, created by an increased RPM, to raise the molten metal to the level for transfer to the reactor vessel (not shown). The launder makeup vessel 80 provides a ready source of molten metal at the same temperature as the operating molten metal bath, and which source can be pumped into the operating bath to return this bath to its normal working level. Launder transfer pumps are available, for example, from Molten Metal Equipment Innovations.

As discussed above, a molten metal reactor is provided, comprising at least the following components a) through c): a) a reactor vessel comprising a molten metal bath, b) a waste input assembly, and c) a product removal assembly.

The embodiments discussed herein apply to the reactor and to processes using the same, unless otherwise noted.

In one embodiment, or a combination of two or more embodiments, each described herein, the reactor further comprises a partition located within the reactor vessel.

In one embodiment, or a combination of two or more embodiments, each described herein, the molten metal of the molten metal bath comprises aluminum (Al), magnesium (Mg), lithium (Li), or any combination thereof. In one embodiment, or a combination of two or more embodiments, each described herein, the molten metal of the molten metal bath comprises aluminum (Al), magnesium (Mg) or any combination thereof.

In one embodiment, or a combination of two or more embodiments, each described herein, the molten metal of the molten metal bath comprises aluminum (Al). In one embodiment, or a combination of two or more embodiments, each described herein, the aluminum (Al) is present in an amount ≥80 wt %, or ≥85 wt %, or >90 wt %, or ≥92 wt %, or ≥94 wt %, or ≥96 wt %, ≥98 wt %, or ≥99 wt %, based on the weight of the molten metal bath and/or present in an amount ≤100 wt %, based on the weight of the molten metal bath.

In one embodiment, or a combination of two or more embodiments, each described herein, the waste input assembly comprises an injection port. In one embodiment, or a combination of two or more embodiments, each described herein, the injection port is inserted vertically into the molten bath.

In one embodiment, or a combination of two or more embodiments, each described herein, the waste input assembly is used to introduce an inert gas into the molten metal bath, In one embodiment, or a combination of two or more embodiments, each described herein, the inert gas is argon. The inert gas, such as argon, may be used to help degas the molten metal bath, such as an aluminum bath, to release trapped gas(es), such as hydrogen, from the bath.

In one embodiment, or a combination of two or more embodiments, each described herein, the product removal assembly is used to remove a majority, by weight, of gaseous products and airborne particulates from the atmosphere above the molten metal bath. In one embodiment, or a combination of two or more embodiments, each described herein, a reactor product comprises one or more forms of (carbon) one or more gases (for example, H₂ and/or H₂O and/or N₂). In one embodiment, or a combination of two or more embodiments, each described herein, the gaseous products comprise H₂ and/or H₂O. In one embodiment, or a combination of two or more embodiments, each described herein, the airborne particulates comprise one or more forms of carbon.

In one embodiment, or a combination of two or more embodiments, each described herein, the reactor further comprises ≥1 plug unit(s), or ≥2 plug units. In one embodiment, or a combination of two or more embodiments, each described herein, each plug unit is used to seal in a positive pressure, inert gas purge in the reactor, to reduce the amount of oxygen that can leak into the reactor. In one embodiment, or a combination of two or more embodiments, each described herein, each plug unit is removable. In one embodiment, or a combination of two or more embodiments, each described herein, the bottom surface of each plug unit is inserted into the molten metal bath. In one embodiment, or a combination of two or more embodiments, each described herein, each plug unit is over an open surface of the reactor vessel, when the reactor is in operation. In one embodiment, or a combination of two or more embodiments, each described herein, all of the open surfaces over the reactor vessel are be covered with one or more plug units, when the reactor is in operation.

In one embodiment, or a combination of two or more embodiments, each described herein, the reactor further comprises ≥1 electric resistance heater, or ≥2 electric resistance heaters, or ≥3 electric resistance heaters, or ≥4 electric resistance heaters, or ≥5 electric resistance heaters, or ≥6 electric resistance heaters, or ≥7 electric resistance heaters, or ≥8 electric resistance heaters. In one embodiment, or a combination of two or more embodiments, each described herein, the reactor further comprises ≤25 electric resistance heaters, or ≤20 electric resistance heaters, or ≤15 electric resistance heaters, or ≤10 electric resistance heaters. In one embodiment, or a combination of two or more embodiments, each described herein, the heating element of each heater is inserted vertically into the molten metal bath, In one embodiment, or a combination of two or more embodiments, each described herein, the electrical power generated by each heater is dissipated as heat into the molten metal bath. This helps to reduce the dissipation of heat (energy) away from the molten metal bath. In one embodiment, or a combination of two or more embodiments, each described herein, each heater is embedded into a moveable plug unit, and further this plug unit is partially inserted, vertically, into the molten metal bath.

In one embodiment, or a combination of two or more embodiments, each described herein, the reactor comprises a closed-circuit recirculating system. In one embodiment, or a combination of two or more embodiments, each described herein, there is no headspace above the molten metal bath, apart from the area under the collection chamber and the area under the slag rake assembly. In one embodiment, or a combination of two or more embodiments, each described herein, each physical piece of equipment, used in the reactor, and which comes into contact with the molten metal, is independently coated with a refractory material (for example, Boron Nitride).

In one embodiment, or a combination of two or more embodiments, each described herein, the molten metal reactor is situated above a sunken pit that serves as a catch basin for the molten metal in the case of a leak, for example a leak in the reactor vessel. The pit also serves as an annulus space for ventilation under the reactor, to keep the adjacent area under the reactor cool.

Also provided is a process to treat waste material, the process comprising adding the waste material to the molten metal reactor of any one embodiment, or a combination of two or more embodiments, each described herein.

### DEFINITIONS

The term “molten metal process,” as used herein, refers to a process to carry out one or more chemical reactions by use of a molten metal bath, and, optionally, to separate and/or collect the one or more reaction products. The molten metal bath may be molten metal alloy bath.

The term “molten metal reactor,” as used herein, refers to an assembly of devices used to carry out one or more chemical reactions by the use of a molten metal bath, and, optionally, to separate and/or collect the one or more reaction products.

The term “reactor vessel,” as used herein, refers to a container that contains a molten metal bath. A molten metal bath comprises one or more metals. The reactor vessel is typically a refractory structure.

The term “molten metal bath,” as used herein, refers to a mass comprising one or more metals in a molten state, and where the bath is contained in a container, such as, for example, a crucible or other refractory container, or a refractory lined reactor vessel. The molten metal may comprise aluminum (Al), magnesium (Mg), lithium (Li), or any combination thereof.

The term “carbon material,”as used herein, refers to one or more forms of carbon. Typically, the carbon material is formed as a particulate solid (or flakes). Examples of carbon materials include the Fullerene allotrope of carbon (see U.S. Pat. No. 11,718,530).

The term “downstream,” as used herein, in reference to a molten metal process or a molten metal reactor, each as described herein, refers to location of a device that occurs later in the process or the reactor, relative to another device.

The term “upstream,” as used herein, in reference to a molten metal process or a molten metal reactor, each as described herein, refers to location of a device that occurs earlier in the process or the reactor, relative to another device.

The term “L_{I}/W_{I} ratio,” as used here, in reference to a reactor vessel, refers to the ratio of the inner length of the reactor vessel to the inner width of the reactor vessel. Each dimension takes into account the respective dimension of a partition, if present, within the reactor vessel. Note, the inner width of the reactor vessel refers to its largest width, and the inner length of the reactor vessel refers to its largest length.

The term “transfer pump,” as used herein, refers to a device used to transfer a stream of molten metal from a molten metal bath to a reactor vessel, to another molten metal bath, or to another device.

The term “circulation pump,” as used herein, refers to a device used to circulate a molten metal bath around a reactor vessel, or other device.

The term “product removal assembly,” as used herein, refers to an assembly of devices used to remove and/or collect one or more products of one or more chemical reactions from a molten metal process.

The term “collection chamber,” as used herein, refer to a device that is used to collect one or more products (for example, one or more carbon materials and/or one or more gases) generated from one or more chemical reactions from a molten metal process.

The term “cyclone separator,” as used herein, refers to a device (typically, commercially available) that is used to remove particulate matter (for example, carbon particles) from a gas stream (or liquid stream or vapor stream). This removal is done typically through a vortex separation and/or a centripetal force. Typically, the particulate matter drops into a collection drum or barrel. A gas stream contains one or more gases. A liquid stream and a vapor stream are each similarly defined.

The term “vortex separation,” as used herein, refers to a method of separating solid(s) from liquid(s) and/or gas(es), or a method of separating droplets of liquid from a gas stream, each method using rotational effects and gravity.

The term “centripetal force,” as used herein, refers to the force necessary to keep an object moving in a curved path, and which force is directed outward toward the center of rotation of the object.

The term “blower,” as used herein, refers to a device that pushes out one or more gases by imparting energy to the gas(es) to increase the energy and speed of the gas(es). This energy may provide the motive energy to support a “closed circuit” recirculating system.

The term “fan,” as used herein, refers to a device with rotating blades that creates a current of one or more gases for cooling and/or ventilation.

The term “waste input assembly,” as used here, refers to an assembly of devices used to transport and/or inject waste material into a molten metal bath. Note, typically, the waste input assembly has an inert gas flowing through this assembly, down to the molten metal bath.

The term “injection port,” as used herein, refers to a device that delivers waste material into the reactor vessel, and preferably beneath the surface of the molten metal bath.

The term “inert gas,” as used herein, refers to a gas that does not change under a given set of conditions. The inert gas, under conditions of interest, does not undergo chemical reactions with other chemical substances, and therefore does not form chemical compounds. Inert gases typically include the noble gases, since such gases often do not react with many substances. Inert gases are used generally to avoid unwanted chemical reactions. These undesirable chemical reactions include, for example, oxidation and hydrolysis reactions with the oxygen and water. The term “inert gas” is context-dependent because an inert gas (for example, several of the noble gases) can be made to react under certain conditions. Purified argon gas is typically the most commonly used inert gas, due to its natural abundance (about 1% argon in air) and low relative cost. The inert gas may also acts as a degassing mechanism to remove hydrogen from the molten metal bath.

The term “refractory molded injection port,” as used herein, refers an injection port formed from a composition comprising a majority amount, by weight, of a refractory material. Typically, such a composition comprises ≥90 wt %, or ≥95 wt %, or ≥98 wt %, or ≥99 wt % of the refractory material, based on the weight of the composition.

The term “refractory material,” as used herein, refers to a material composition that shows resistance to the temperatures, pressures, and chemicals in a reaction and/or process of interest. Typically, the refractory material is resistant to high temperatures (for example, temperatures ≥melting temperature of a molten metal, or for example, temperatures ≥1000° F. (538° C.), or ≥1500° F. (816° C.), or ≥2000° F. (1093° C.)). A refractory material can be used to seal and coat surfaces of a reactor of interest. Refractory materials comprise natural and/or synthetic materials, such as, for example, nonmetallic compounds and minerals, or combinations of such compounds and minerals. Refractory materials include, but are not limited to, boron nitride, alumina, fireclays, bauxite, chromite, dolomite, magnesite, silicon carbide, zirconia, and combinations thereof. Examples of refractory materials include BORON NITRIDE PRODUCTS available from Materion.

The term “refractory block,” as used herein, refers to a refractory material, used to build (for example, by pouring) a piece of equipment (for example, a plug unit). A refractory block is designed mainly to withstand high heat, but should also usually have a low thermal conductivity to save energy. An example of a refractory block is the refractory material PILCAST AL-SHIELD 2765 KK available from Plibrico Company, LLC.

The term “gas burner,” as used herein, refers to a heating device that operates by burning one or more gases, such as, for example, natural gas. Examples of gas burners include natural gas forced air burners. Typically, gas burners are used in gas fired Reverb Furnaces.

The term “electric resistance heater,” as used herein, refers to a device that comprises at least one heating element that converts electrical energy into heat.

The terms “linear flow,” or “linear flow pattern,” each as used herein, refer to a flow regime characterized by parallel flow lines in a molten metal bath.

The terms “partially turbulent flow,” or “partially turbulent flow pattern,” as used herein, refer to a flow regime characterized by a combination of linear flow and turbulent flow (the speed of a fluid at a point is continuously undergoing changes in magnitude and direction) in a molten metal bath. A partially turbulent flow is desired to facilitate adequate mixing.

The term “closed-circuit recirculating system,” as used herein, refers to a molten metal process or a molten metal reactor, or a reactor component, such as a product collection system, in which each process, reactor, or reactor component is not open to the atmosphere. Typically, such a process, reactor or reactor component comprises piping, ductwork, connections, and flow inducing devices, all involved in transporting, for example, a gas and/or a diffused matter within a gas, from an emission point to a control device and/or to a separation device.

The term “drop tube,” as used herein, refers to a device (for example, a pipe) inserted into a process, and where the device serves to redirect and temporarily slow down the movement or flow of matter, to allow particulate or sediment to “drop out” of the flow path. The drop tube is typically a vertical device that is inserted into a horizontal pipe or tube, and which device collects the “dropped out” material. Typically, the drop tube has an opening at its bottom that can be opened periodically to collect the trapped (dropped out) material. Downstream of the drop tube, the flow rate typically returns to its normal velocity.

The term “gas recycling device,” as used herein, refers to an apparatus used to separate one or more gasses (for example, hydrogen) from an emission stream, and to, independently, collect each gas and/or recycle each gas back to a reactor. It is noted that a recycled inert gas, after the removal of other gases, such as hydrogen, can be recycled to the product removal area and/or the waste input area.

The term “selective permeation membrane,” as used herein, refers to a membrane that selectively allows certain molecules and/or ions to pass through it by, for example, a diffusion mechanism, such as a gaseous diffusion. An example of a selective permeation membrane is a SEPURAN NOBLE membrane device available from Evonik. Other examples include palladium membranes and zeolite membranes.

The phrase “a majority of,” or similar phrases or terms, as used herein, refer to ≥50% of the weight, dimension, area, volume, or amount of the subject of interest.

The phrase “recirculation fan in the axial position,” as used herein, refers to a recirculation fan situated axially to the flow of the atmosphere moving through the fan.

The phrase “physical piece of equipment,” as used herein, refers to a piece of equipment or a device used in a process or reactor of interest.

The term “slag rake assembly,” as used herein, refers to an assembly of devices, and which assembly is used to remove slag from the surface of a molten metal bath.

The term “slag rake,” as used herein, refers to a device used to remove slag from the surface of a molten metal bath. Typically, the slag rake comprises one or more slag paddle devices, and preferably two slag paddle devices.

The term “slag paddle device” as used herein, in reference to a slag rake, refers to the components that make up a functioning slag paddle for the purpose of removing slag from the surface of a molten metal bath.

The term “slag paddle” as used herein, in reference to a slag paddle device, refers to a structure used to remove slag from the surface of the molten metal bath. See, for example, FIG. 8 (item 40).

The term “slag,” as used herein, refers to a reaction product comprising one or more metal oxides. Such metal oxides are typically formed when oxygen comes into contact with a molten metal bath.

The phrase “central surface area of the slag rake,” as used herein, refers to the inner surface of the length of the slag rake. A slag rake, as described herein, has two length sections, where each inner surface faces the inner surface of the other length section. Typically, each inner surface is encompassed within, and surrounded by, an elongated oblong track. See, for example, FIG. 7 (item 41).

The term “insert,” as used herein, refers to a structure used to guide each slag paddle to an outlet chamber. See, for example, FIG. 11 (item 64).

The term “outlet chamber,” as used herein, refers to a container used to receive slag collected from the surface of a molten metal bath, and which slag is typically transferred along an insert to this chamber. An outlet door is typically located at the bottom of the chamber, which door opens to release the slag into a slag collection chamber, and then recloses to prevent the migration of oxygen into the process closed environment.

The term “slag collection container,” as used herein, refer to a container that is used to collect slag that falls from an outlet door.

The term “metal oxide,” as used herein, refers to a compound comprising oxygen, and at least one metal and/or at least one metalloid. Examples include, but are not limited to, Al₂O₃ (aluminum (III) oxide), AlO (aluminum (II) oxide), Al₂O (aluminum (I) oxide), and SiO₂ (silicon (IV) oxide).

The term “plug unit,” as used herein, refers to a planar structure (for example, top surface area or base surface area >10× the area of a side (or edge) surface). A plug unit is typically formed from a refractory material and/or one or more high temperature resistant metals. The plug unit can acts as a shield to prevent the migration of oxygen to the molten metal bath. It can also provide a surface for the mounting of pumps, heaters, inspection points, thermocouples, and other instruments. The plug unit typically has lifting pad eyes that provide points of attachment for a lifting device, such as a traveling overhead crane. A plug unit is typically readily accessible, and can be readily removed for repair or replacement, or for the repair or replacement of a mounted device, thus reducing the amount of time lost to equipment failure and repair. See, for example, FIG. 12. The plug unit is typically formed from a refractory material, such as, for example, PLICAST AL-TUFF 3100 SPECIAL KK (available from Plibrico Company, LLC) and/or one or more high temperature resistant metals (metals or metal alloys that typically have a melting point above 2000° C. (3632° F.)).

The term “structural support,” as used herein, refers to a component that supports non-variable forces or weights (dead loads) and variable forces or weights (live loads).

The term “partition,” as used herein, refers to a structure used to divide or separate portions of a molten metal bath. See, for example, FIG. 1 (item 14).

The phrase “reactor is in operation,” and similar phrases, as used herein, refer to the injection of waste material into a molten metal, the subsequent reaction of the waste material with the molten metal bath, and, optionally, the separation and/or collection of the reaction product(s).

The term “headspace,” as used herein, refers to the atmosphere above the molten metal bath surface.

The term “makeup molten metal,” as used herein, refers to the molten metal that is used to replenish the amount of the molten metal bath consumed in the formation of slag and/or other reaction(s).

The term “sunken pit,” as used herein, refers to a pit that comprises a base that is lower, on all sides, than the surrounding floor area. The sunken pit may serve as a catch basin for the molten metal in the case of a leak, such as, for example, a leak in a reactor vessel. The pit may also serves as an annulus space for ventilation under the reactor, to keep the adjacent area under the reactor at a cooler temperature.

The term “input hopper,” as used herein, refers to a device, such as, for example, a tray, a bin, or a chute, that accepts waste materials.

The term “shredder,” as used herein, refers to a device that tears and/or cuts objects into smaller pieces.

The term “auger conveyor,” as used herein, refers to a device that comprises a rotating helical screw and/or blade, each within a tube, and which is used to move liquid or solid (for example, granular) material(s). This device can be used horizontally or at an incline as an efficient way to move the material(s).

The term “vertical screw auger,” as used herein, refers to a device that comprises a rotating helical screw and/or blade, each within a tube, and which is used to move liquid or solid (for example, granular) material(s) in a vertical direction.

The term “waste” or “waste material,” as used herein, refer to unwanted and/or unusable materials. Waste includes non-hazardous waste and hazardous waste. Examples of non-hazardous waste include, but are not limited to, industrial non-hazardous waste (for example, paper and plastic products; construction and demolition debris; extraction and mining waste; non-hazardous oil and gas production waste; and non-hazardous medical waste).

The term “hazardous waste” or “hazardous waste material,” as used herein, refers to waste that poses one or more substantial and/or potential threats to the public health and/or the environment. Typically, such waste has one or more of the following properties: ignitability, reactivity (for example, reactivity with water), corrosivity, and/or toxicity. Examples of hazardous waste includes, but is not limited to, medical waste, nuclear waste and toxic waste.

The term “halogenated organics,” as used herein, refers to one or more organic molecules, each comprising at least one halogen atom.

The “Temperature (TI)” of the molten metal (or molten metal bath) in the reactor vessel, as used herein, refers to the average temperature of the temperatures from four or more thermocouples located at various positions in the molten metal bath.

The term “on-line feed system,” as used herein, refers to the apparatus (for example, piping components and gauges) used to feed to a reactor (for example, to the waste input assembly), a chemical (for example an inert gas) from a manufacturing plant that produces the chemical.

The term “gas back pressure,” as used herein in reference to a gas flow, through a gas flow meter, refers to the pressure measured at the outlet side of the gas flow meter.

### Listing of Some Reactor and Process Features

A] A molten metal reactor comprising at least the following components a) through c):
   a) a reactor vessel comprising a molten metal bath,
   b) a waste input assembly, and
   c) a product removal assembly.
B] The molten metal reactor of A] above, wherein the reactor vessel has an inner length (L_{I}) and an inner width (W_{I}). Note, the inner width (W_{I}) of the reactor vessel refers to its largest width, and the inner length (L_{I}) of the reactor vessel refers to its largest length.
C] The molten metal reactor of B] above, wherein the ratio of the inner length of the reactor vessel to the inner width of the reactor vessel, or L_{I}/W_{I}, is ≥1.0, or ≥1.2, or ≥1,5, or ≥1.8, or ≥2.0.
D] The molten metal reactor of B] or C] above, wherein the ratio of the inner length of the reactor vessel to the inner width of the reactor vessel, or L_{I}/W_{I}, is ≤4.0, or ≤3.7, or ≤3.5, or ≤3.2, or ≤3.0, or ≤2.8, or ≤2.5.
E] The molten metal reactor of any one of A]-D] (A] through D]) above, wherein the reactor further comprises a partition located within the reactor vessel.
F] The molten metal reactor of E] above, wherein the partition sets on the bottom surface of the reactor vessel, and further the partition is bolted to the bottom surface of the reactor vessel.
G] The molten metal reactor of E] or F] above, wherein the partition has a length (L_{P}) and a width (W_{P}). Note, the width (W_{P}) of the partition refers to its largest width, and the length (L_{P}) of the partition refers to its largest length.
H] The molten metal reactor of one of E]-G] above, wherein the ratio of the length of the partition to the inner length of the reactor vessel, or L_{P}/L_{I}, is ≥0.50, or ≥0.60, or ≥0.70 and/or ≤0.90, or ≤0.85, or ≤0.80.
I] The molten metal reactor of one of E]-H] above, wherein the ratio of the width of the partition to the inner width of the reactor vessel, or Wp_{P}/W_{I}, is ≥0.20, or ≥025, or ≥0.30 and/or ≤0.50, or ≤0.45, or ≤0.40.
J] The molten metal reactor of any one of A]-I] above, wherein the molten metal of the molten metal bath comprises aluminum (Al), magnesium (Mg), lithium (Li), or any combination thereof, or the molten metal bath comprises aluminum (Al), magnesium (Mg) or any combination thereof, or the molten metal bath comprises aluminum (Al).
K] The molten metal reactor of J] above, wherein the aluminum (Al) is present in an amount ≥80 wt %, or ≥85 wt %, or ≥90 wt %, or ≥92 wt %, or ≥94 wt %, or ≥96 wt %, 2 98 wt %, or 2 99 wt %, based on the weight of the molten metal bath and/or present in an amount ≤100 wt %, based on the weight of the molten metal bath.
L] The molten metal reactor of any one of A]-K] above, wherein the temperature of the molten metal bath (T1) is ≥600° F.(316° C.), or >650° F.(343° C.), or >700° F.(371° C.), or ≥750° F. (399° C.), or ≥800° F. (427° C.), or ≥850° F. (454° C.), or ≥900° F. (482° C.), or ≥950° F. (510° C.), or ≥1000° F. (538° C.), or >1050° F. (566° C.), or ≥1100° F. (593° C.), or ≥1150° F. (621° C.), or ≥1200° F. (644° C.), or ≥1250° F. (677° C.), or ≥1300° F. (704° C.), or ≥1350° F. (732° C., or ≥1400° F. (760° C.), or ≥1450° F. (788° C.), or ≥1500° F. (816° C.), or ≥1550° F. (843° C.).
M] The molten metal reactor of any one of A]-L] above, wherein the temperature of the molten metal bath (T1) is ≤2000° F. (1093° C.), or ≤1950° F. (1066° C.), or ≤1900° F. (1038° C.), or ≤1850° F. (1010° C.), or ≤1800° F. (982° C.), or ≤1750° F. (954° C.), or ≤1700° F. (927° C.), or ≤1650° F. (899° C.), or ≤1600° F. (871° C.).
N] The molten metal reactor of any one of A]-M] above, wherein the temperature of the molten metal bath (T1) is ≥1221° F. (661° C.), or ≥1230° F. (666° C.), or ≥1240° F. (671° C.), or>1260° F.(682° C.), or ≥1280° F. (693° C.), or ≥1300° F.(704° C.), or ≥1320° F.(716° C.), or ≥1340° F. (727° C.), or ≥1360° F. (738° C.), or ≥1380° F. (749° C.), or ≥1400° F. (760° C.), or ≥1420° F. (771° C.), or ≥1440° F. (782° C.), or >1460° F.(793° C.), or >1480° F.(804° C.), or >1500° F.(816° C.), or >1520° F.(827° C.), or ≥1540° F. (838° C.).
O] The molten metal reactor of any one of A]-N] above, wherein the temperature of the molten metal bath (T1) is ≤1850° F. (1010° C.), or ≤1800° F. (982° C.), or ≤1780° F. (971° C.), or ≤1750° F. (954° C.), or ≤1720° F. (938° C.), or ≤1700° F. (927° C.), or ≤1680° F. (916° C.), or ≤1650° F. (899° C.), or ≤1620° F. (882° C.), or ≤1600° F. (871° C., or ≤1580° F. (860° C.).
P] The molten metal reactor of any one of A]-O] above, wherein the waste input assembly comprises an injection port.
Q] The molten metal reactor of P] above, wherein the injection port is inserted vertically into the molten metal bath.
R] The molten metal reactor of P] or Q] above, wherein the injection port has an outer surface that promotes a dual venturi annulus of the molten metal bath around the exit of the injection port.
S] The molten metal reactor of any one of P]-R] above, wherein ≥90%, or ≥92%, or ≥94%, of ≥96%, or ≥98%, or >99% and/or ≤100% of the outer surface of the injection port is inserted beneath the surface of the molten metal bath.
T] The molten metal reactor of any one of A]-S] above, wherein the waste input assembly further comprises an input hopper, a shredder, an auger conveyor, and a vertical screw auger.
U] The molten metal reactor of T] above, wherein the shredder is located at the bottom end of the input hopper.
V] The molten metal reactor of T] or U] above, wherein the vertical screw auger is located on the top surface of a plug unit.
W] The molten metal reactor of V] above, plug unit is removable.
X] The molten metal reactor of any one of T]-W] above, wherein the auger conveyor is located between the input hopper and the vertical screw auger,
Y] The molten metal reactor of any one of T]-X] above, wherein the shredder is used to shred waste added to the input hopper, to form a shredded waste.
Z] The molten metal reactor of any one of T]-Y] above, wherein the auger conveyor routes waste to the vertical screw auger.
A2] The molten metal reactor of any one of T]-Z] above, wherein the vertical screw auger routes the waste to the injection port.
B2] The molten metal reactor of any one of V]-A2] above, wherein an injection port is located on the bottom surface (surface above the molten metal bath) of the plug unit; further the injection port is inserted vertically into the molten metal bath; and further ≥90%, or ≥92%, or ≥94%, of ≥96%, or ≥98%, or ≥99% and/or ≤100% of the outer surface of the injection port is inserted beneath the surface of the molten metal bath.
C2] The molten metal reactor of any one of T]-B2] above, wherein waste that is added to the input hopper comprises paper, plastic, medical waste, or any combination thereof; and further the shredder is used to shred waste added to the input hopper, to form a shredded waste.
D2] The molten metal reactor of any one of T]-B2] above, wherein the waste that is added to the input hopper comprises hazardous waste or halogenated organics or any combination thereof.
E2] The molten metal reactor of any one of A]-D2] above, wherein the waste input assembly is used to introduce an inert gas into the molten metal bath.
F2] The molten metal reactor of E2] above, wherein the inert gas reduces the surface tension of the metal atoms and/or metal ions on the surface of the molten metal bath, as compared to the same reactor and bath conditions, except for the exclusion of the inert gas.
G2] The molten metal reactor of E2] or F2] above, wherein inert gas is injected, at a pressure ≥0.50 psi, at a rate of ≥2.0 L/min, or ≥2.2 L/min, or ≥2.4 L/min, or ≥2.6 L/min, or ≥2.8 L/min, or ≥3.0 L/min. The pressure is the gas back pressure.
H2] The molten metal reactor of any one of E2]-G2] above, wherein the inert gas is injected, at a pressure ≥0.50 psi, at a rate of ≤5.0 L/min, or ≤4.8 L/min, or ≤4.6 L/min, or ≤4.4 L/min, or ≤4.2 L/min, or ≤4.0 L/min.
I2] The molten metal reactor of E2] or F2] above, wherein inert gas is injected, at a pressure ≥3.0 psi, at a rate of ≥4.0 L/min, at a rate of ≥5.0 L/min, or ≥6.0 L/min, or ≥7.0 L/min, or ≥8/0 L/min, or ≥9.0 L/min, or ≥10 L/min. The pressure is the gas back pressure.
J2] The molten metal reactor of E2] or F2] or I2] above, wherein inert gas is injected, at a pressure ≥3.0 psi, at a rate of ≤30 L/min, or ≤25 L/min, or ≤20 L/min, or ≤15 L/min.
K2] The molten metal reactor of any one of E2]-J2] above, wherein the inert gas is recycled using a gas recycling device comprising a selective permeation membrane.
L2] The molten metal reactor of any one of E2]-K2] above, wherein the inert gas is argon.
M2] The molten metal reactor of any one of A]-L2] above, wherein the product removal assembly is used to remove one or more gaseous products and one or more airborne particulates from the atmosphere above the molten metal bath, and further to remove a majority, by weight, of the one or more gaseous products and the one or more airborne particulates from the atmosphere above the molten metal bath; and further to remove ≥90 wt % of the one or more gaseous products and the one or more airborne particulates from the atmosphere above the molten metal bath. Each removal occurs when the reactor is in operation.
N2] The molten metal reactor of any one of A]-M2] above, wherein the product removal assembly comprises a collection chamber.
O2] The molten metal reactor of any one of A]-N2] above, wherein the product removal assembly comprises ≥1 cyclone separator(s), or ≥2 cyclone separators, or ≥3 cyclone separators.
P2] The molten metal reactor of O2] above, wherein each cyclone is used to separate one or more airborne particulates from one or more gaseous products.
Q2] The molten metal reactor of any one of A]-P2] above, wherein the product removal assembly comprises at least two cyclone separators in a parallel configuration.
R2] The molten metal reactor of Q2] above, wherein the at least two cyclone separators, in a parallel configuration, are each in a series configuration with at least one cyclone separator. See, for example, FIG. 5.
S2] The molten metal reactor of any one of N2]-R2] above, wherein the collection chamber comprises a closed-circuit recirculating system.
T2] The molten metal reactor of any one of N2]-S2] above, wherein the collection chamber produced a cross-flow ventilation that sweeps one or more gaseous products and one or more airborne particulates to at least one cyclone separator, and further to at least two cyclone separators.
U2] The molten metal reactor of T2] above, wherein the one or more gaseous products are separated from the one or more airborne particulates in each cyclone separator; and further at least a majority (wt %) of the one or more gaseous products are separated from the one or more airborne particulates in each cyclone separator.
V2] The molten metal reactor of any one of L2]-U2] above, wherein the collection chamber comprises one or more blowers.
W2] The molten metal reactor of any one of N2]-V2] above, wherein the collection chamber comprises one or more fans; and further each fan is a recirculation fan in the axial position.
X2] The molten metal reactor of any one of A]-W2] above, wherein the product removal assembly comprises one or more drop tubes. See, for example, FIG. 5.
Y2] The molten metal reactor of any one of M2]-X2] above, wherein the one or more gaseous products comprise hydrogen (H₂).
Z2] The molten metal reactor of any one of M2]-Y2] above, wherein the one or more airborne particulates comprise a carbon material.
A3] The molten metal reactor of Z2] above, wherein the carbon material is in a particulate form (for example, a flake).
B3] The molten metal reactor of any one of A]-A3] above, wherein the reactor further comprises ≥1 plug unit(s), or ≥2 plug units.
C3] The molten metal reactor of B3] above, wherein each plug unit is used to seal in a positive pressure, inert gas purge in the reactor, to reduce the amount of oxygen that can leak into the reactor.
D3] The molten metal reactor of B3] or C3] above, wherein each plug unit is removable.
E3] The molten metal reactor of any one of B3]-D3] above, wherein each plug unit can be moved by a lifting device (such as, for example, a traveling overhead crane).

F3] The molten metal reactor of any one of B3]-E3] above, wherein the bottom surface of each plug unit is inserted into the molten metal bath.
G3] The molten metal reactor of any one of B2]-F3] above, wherein the bottom surface of each plug unit is independently inserted into the molten metal bath, at a depth of ≥0.20 inch (0.51 cm), or ≥0.30 inch (0.76 cm), or ≥0.40 inch (1.0 cm), or ≥0.50 inch (1.3 cm), as measured from the bottom surface of the plug unit.
H3] The molten metal reactor of any one of B3]-G3] above, wherein the bottom surface of each plug unit is independently inserted into the molten metal bath, at a depth of ≤3.0 in (7.62 cm), or ≤2.5 in (6.4 cm), or ≤2.0 in (5.1 cm), or ≤1.5 in (3.8 cm), as measured from the bottom surface of the plug unit.
I3] The molten metal reactor of any one of B3]-H3] above, wherein each plug unit is over an open surface of the reactor vessel, when the reactor is in operation.
J3] The molten metal reactor of any one of B3]-[3] above, wherein each plug unit may provide structural support for one or more other pieces of equipment.
K3] The molten metal reactor of any one of AJ-J3] above, wherein the reactor further comprises ≥1 electric resistance heater, or ≥2 electric resistance heaters, or ≥3 electric resistance heaters, or ≥4 electric resistance heaters, or ≥5 electric resistance heaters, or ≥6 electric resistance heaters, or ≥7 electric resistance heaters, or ≥8 electric resistance heaters.
L3] The molten metal reactor of any one of A]-K3] above, wherein the reactor further comprises ≤25 electric resistance heater, or ≤20 electric resistance heaters, or ≤15 electric resistance heaters, or ≤10 electric resistance heaters.
M3] The molten metal reactor of K3] or L3] above, wherein the heating element of each heater is inserted vertically into the molten metal bath.
N3] The molten metal reactor of any one of K3]-M3] above, wherein each heater is embedded into a removeable plug unit, and further the bottom surface of the plug unit is partially inserted into the molten metal bath.
O3] The molten metal reactor of any one of K3]-N3] above, wherein each heater generates ≥5,000 kilowatts, or ≥8,000 kilowatts, or ≥10,000 kilowatts, or ≥12,000 kilowatts, or ≥14,000 kilowatts of electrical power.
P3] The molten metal reactor of any one of K3 ]-O3] above, wherein each heater generates ≤30,000 kilowatts, or ≤25,000 kilowatts, or ≤20,000 kilowatts of electrical power.
Q3] The molten metal reactor of any one of K3 ]-P3] above, wherein the electrical power generated by each heater is dissipated as heat into the molten metal bath.
R3] The molten metal reactor of any one of A]-Q3] above, wherein the reactor further comprises at least one pump that provides for the circulation of the molten metal bath around the reactor vessel.
S3] The molten metal reactor of any one of A]-R3] above, wherein the molten metal bath travels around the perimeter of the reactor vessel in a partially turbulent flow pattern.
T3] The molten metal reactor of any one of A]-S3] above, wherein the molten metal bath travels around the perimeter of the reactor vessel at a speed of ≥0.125 RPM. Here, “1 RPM” means that the total inventory of the molten metal in the reactor will complete one circuit of the reactor vessel, in one minute.
U3] The molten metal reactor of T3] above, wherein one circuit of the reactor vessel is ≥30 ft (9.1 m), or ≥35 ft (11 m), or ≥40 ft (12 m), or ≥45 ft (14 m), or ≥50 ft (15 m).
V3] The molten metal reactor of T3] or U3] above, wherein one circuit of the reactor vessel is ≤100 ft (30 m), or ≤95 ft (29 m), or ≤90 ft (27 m), or ≤85 ft (26 m), or ≤80 ft (24 m), or ≤75 ft (23 m), or ≤70 ft (21 m), or ≤65 ft (20 m), or ≤60 ft (18 m).
W3] The molten metal reactor of any one of A]-V3] above, wherein slag is produced in the reactor vessel; and further the slag rises to the surface of the molten metal bath.
X3] The molten metal reactor of W3] above, wherein the slag comprises one or more metal oxides.
Y3] The molten metal reactor of any one of A]-X3] above, wherein the reactor further comprises a slag rake assembly.
Z3] The molten metal reactor of Y3] above, wherein the slag rake assembly is used to remove slag from the surface of the molten metal bath.
A4] The molten metal reactor of Y3] or Z3] above, wherein the slag rake assemble comprises a slag rake.
B4] The molten metal reactor of A4] above, wherein the slag rake comprises at least one slag paddle device that comprises a slag paddle and a solid rod, and further the slag rake comprises two slag paddle devices.
C4] The molten metal reactor of B4] above, wherein the solid rod is formed from a composition comprising at least one metal.
D4] The molten metal reactor of B4] or C4] above, wherein a portion of each slag paddle is submerged beneath the surface of the molten metal bath, to collect the slag on the surface of the bath.
E4] The molten metal reactor of any one of B4]-D4] above, wherein each slag paddle device travels around a central surface area of the slag rake, when the reactor is in operation.
F4] The molten metal reactor of any one of B4]-E4] above, wherein a chain and sprocket mechanism or a pully mechanism is used to move each slag paddle device around a track on the slag rake.
G4] The molten metal reactor of any one of A]-F4] above, wherein the molten metal reactor further comprises an insert, an outlet chamber, and a slag collection container, and further the outlet chamber comprises an outlet door.
H4] The molten metal reactor of G4] above, wherein the slag paddle transports the slag along the insert to the outlet chamber.
I4] The molten metal reactor of G4] or I4] above, wherein the outlet door is located at the bottom of the outlet chamber.

J4] The molten metal reactor of any one of G4]-14] above, wherein the outlet door opens when in contact with the slag, and the slag drops into the slag collection container.
K4] The molten metal reactor of any one of A]-J4] above, wherein the reactor further comprises a launder makeup vessel and a transfer pump.
L4] The molten metal reactor of K4] above, wherein the launder makeup vessel and the transfer pump are used to supply makeup molten metal to the molten metal bath in the reactor vessel.
M4] The molten metal reactor of any one of A]-L4] above, wherein the reactor comprises a closed-circuit recirculating system.
N4] The molten metal reactor of any one of Y3]-M4] above, wherein there is no headspace above the molten metal bath, apart from the area under the collection chamber and the area under the slag rake assembly.
O4] The molten metal reactor of any one of AJ-N4] above, wherein each physical piece of equipment, used in the reactor, and which comes into contact with the molten metal, is independently coated with a refractory material.
P4] The molten metal reactor of O4] above, wherein the refractory material comprises boron nitride.
Q4] The molten metal reactor of O4] or P4] above, wherein each refractory material is thermally resistant at a temperature of ≥1000° F. (538° C.), or ≥1200° F. (649° C.), or ≥1400° F. (760° C.), or ≥1600° F. (871° C.), or ≥1800° F. (982° C.), or ≥2000° F. (1093° C.).
R4] The molten metal reactor of any one of M2]-Q4] above, wherein the one or more gaseous products do not comprise CO₂.
S4] The molten metal reactor of any one of E2]-R4] above, wherein the inert gas helps to degas the molten metal bath to release one or more trapped gases, from the molten metal bath; and further helps to release hydrogen (H₂) from the bath.
T4] The molten metal reactor of any one of Y2]-S4] above, wherein the hydrogen is separated and collected.
U4] The molten metal reactor of T4] above, wherein the hydrogen is separated using a device comprising a selective permeation membrane.
V4] The molten metal reactor of T4] or U4] above, wherein the hydrogen flows through a vent in the collection chamber.
W4] The molten metal reactor of any one of F2]-V4] above, wherein the inert gas is fed to the waste input assembly using an on-line feed system.
A5] A process to treat waste material, the process comprising adding the waste material to the molten metal reactor of any one of A]-W4] above.
B5] The process of A5] above, wherein the reduction in the volume of the waste material treated is ≥50%, or ≥55%, or ≥60%, or ≥65%. or ≥70%, or ≥75%, or ≥80%, relative to the volume of the waste material added to the molten metal bath in the reactor vessel.
C5] The process of A5] or B5] above, wherein the reduction in the volume of the waste material treated is <100%, or <98%, or >96%, or <94%. or <92%, or <90%, relative to the volume of the waste material added to the molten metal bath in the reactor vessel.

### EXPERIMENTAL

A molten bath reaction may be run in accordance with FIGS. 1-5, 7 (slag rake optional), 11 (optional) and 13-15.

Note, a molten aluminum bath may be used, and the molten metal bath is already established, and in a “phase 3” operational mode.

The exposed surfaces of the reactor vessel are covered with one or more plug units. Each component of the reactor that comes into contact with the molten metal bath is independently coated with a refractory, such as boron nitride.

Argon gas with a purity of ≥99 vol %, for example from Airgas, based on the volume of argon gas used.

Injection flow rate of the argon gas of 10 L/min, at a pressure gas back pressure of about 4.0 psi or higher. The reactor is purged with argon gas, and this purge remains throughout the operation of the reactor.

A thermocouple will be placed in the injection port to ensure the port is operating properly and there are no blockages.

Description of partition-longitudinal partition that is centered in the reaction vessel.

The Ly/WI ratio of reactor vessel (including the partition) =2.5.

Composition of molten metal bath is ≥99 wt % Al, based on the weight of the molten metal.

At least one circulation pump.

Four electric resistance heater, each generating 17,000 kilowatts of electrical power. The heating element of each heater is inserted into the molten metal bath to minimize heat dissipation to areas outside the reactor vessel.

Product removal assembly-see FIG. 5. Three cyclone separators (two in parallel configuration and the last in series configuration) and three drop tubes. A thermocouple will be placed inside the collection chamber.

Temperature (T1) of the molten metal in the reactor vessel is around 1450° F. to 1500° F. (788° C. to 816° C.). Temperature T1 is the average temperature of the temperatures noted on the following thermocouples: a) four thermocouples located on each corner of the reactor vessel, b) one thermocouple located downstream from the injection port, and c) two thermocouples located within the bath, near the inlet and outlet, respectively, of the circulation pump.

The speed the molten metal bath travels around the of the reactor vessel =0.2 RPM (one circuit of the “total inventory of the molten metal in the reactor vessel”in 1 minute.

As discussed, plug units are used to cover all the open areas above the molten metal bath. Note a slag rake assembly may optionally be used to remove slag-see FIGS. 7 and 11. Note, each thermocouple output will be recorded with video display of the operating parameters. Operating set points will be established, and the data collected will control the power output of the heaters, pumps and fans used to maintain the molten aluminum at the desired temperature.

The reactor is purged with argon gas, and this purge remains throughout the operation of the reactor. About 2000 cubic feet of paper/plastic waste is transported in smaller units via a conveyor belt to the hopper. The shredder at the bottom of the hopper shreds the waste into a “confetti-type” size to increase the surface area of the waste. The “confetti-type” material travels through the auger conveyor to the vertical screw auger, located on the top surface of a plug unit, which plug unit, in turn, is located over the surface of the molten metal bath. The bottom surface of the plug unit is inserted into the molten metal bath. The vertical screw auger pushes the material through an injection port, located on the bottom surface of the plug unit, and into the molten aluminum bath.

Upon contact with the molten metal bath, the waste begins to dissociate primarily into forms of carbon and one or more gases. These reaction products rise to the surface of the bath and are carried along with the purge gas to the collection chamber. The cross-flow ventilation in the collection chamber sweeps the products towards the two cyclone separators, arranged in a parallel configuration. Each separator uses a vortex separation and/or a centripetal force to transport the particles to a respective collection barrel. These two cyclone separators discharge into a third cyclone separator to assure a maximum collection of the airborne particles. In addition, downstream, three drop tubes assist in scavenging the remainder of the fugitive particles, prior to recirculation of the purge gas to an axial circulating fan and then to the inlet of the collection chamber. Gases other than the inert gas may be separated via a vent in the collection chamber, and may be collected using other devices. The particles may be collected and packaged. If slag is formed, it can be removed using the slag rake assembly.

The above described embodiments are intended to illustrate the principles of the processes and reactors described herein, but not to limit the scope of the invention. Various other embodiments and modifications to these embodiments may be made by those skilled in the art, without departing from the scope of the following claims.

1. A molten metal reactor comprising at least the following components a) through c):
a) a reactor vessel comprising a molten metal bath,
b) a waste input assembly, and
c) a product removal assembly.

2. The molten metal reactor of claim 1, wherein the reactor further comprises a partition located within the reactor vessel.

3. The molten metal reactor of claim 1, wherein the molten metal of the molten metal bath comprises aluminum (Al), magnesium (Mg), lithium (Li), or any combination thereof.

4. The molten metal reactor of claim 1, wherein the molten metal of the molten metal bath comprises aluminum (Al), magnesium (Mg) or any combination thereof.

5. The molten metal reactor of claim 1, wherein the molten metal of the molten metal bath comprises aluminum (Al).

6. The molten metal reactor of claim 1, wherein the waste input assembly comprises an injection port.

7. The molten metal reactor of claim 6, wherein the injection port is inserted vertically into the molten metal bath.

8. The molten metal reactor of claim 1, wherein the waste input assembly is used to introduce an inert gas into the molten metal bath.

9. The molten metal reactor of claim 1, wherein the product removal assembly is used to remove gaseous products and airborne particulates from the atmosphere above the molten metal bath.

10. The molten metal reactor of claim 1, wherein the reactor further comprises ≥1 plug unit(s).

11. The molten metal reactor of claim 10, wherein each plug unit is used to seal in a positive pressure, inert gas purge in the reactor, to reduce the amount of oxygen that can leak into the reactor.

12. The molten metal reactor of claim 10, wherein each plug unit is removable.

13. The molten metal reactor of claim 10, wherein the bottom surface of each plug unit is inserted into the molten metal bath.

14. The molten metal reactor of claim 10, wherein each plug unit is over an open surface of the reactor vessel, when the reactor is in operation.

15. The molten metal reactor of claim 1, wherein the reactor further comprises from 1 to 25 electric resistance heaters.

16. The molten metal reactor of claim 15, wherein the heating element of each heater is inserted vertically into the molten metal bath.

17. The molten metal reactor of claim 15, wherein each heater is embedded into a removeable plug unit.

18. The molten metal reactor of claim 15, wherein the electrical power generated by each heater is dissipated as heat into the molten metal bath.

19. The molten metal reactor of claim 1, wherein the reactor comprises a closed-circuit recirculating system.

20. The molten metal reactor of claim 1, wherein there is no headspace above the molten metal bath, apart from the area under a collection chamber and the area under a slag rake assembly.

21. The molten metal reactor of claim 1, wherein each physical piece of equipment, used in the reactor, and which comes into contact with the molten metal bath, is independently coated with a refractory material.

22. A process to treat waste material, the process comprising adding the waste material to the molten metal reactor of claim 1.
